(19) United States
(12) Patent Application Publication
(10) Pub. No.: US 2024/0257145 A1
(43) Pub. Date: Aug. 1, 2024

(54) REMOTE CUSTOMER SERVICE SYSTEM

(71) Applicant: SHARP KABUSHIKI KAISHA, Osaka (JP)

(72) Inventors: Hidenori ISHII, Osaka (JP); Kazuo Nishiura, Osaka (JP)

(21) Appl. No.: 18/420,756

(22) Filed: Jan. 23, 2024

(30) Foreign Application Priority Data
Jan. 26, 2023 (JP) 2023-010315

(51) Int. Cl. G06Q 30/015; G06Q 30/02

(52) U.S. Cl. CPC G06Q 30/015; G06Q 30/0281

(57) ABSTRACT

A remote customer service system includes an acquiring device that acquires customer information including feature information indicating a feature of a customer who visits a store, a plurality of operator terminal devices used in an operation to provide customer service information to the customer by a plurality of operators capable of serving the customer, an operator selection device that selects one operator from the plurality of operators, and a store terminal device that presents the customer service information to the customer. In the operator selection device, a selector selects an operator suitable for the customer, based on the customer information and operator information stored in a storage and indicating characteristics of the operators.

### INCORPORATION BY REFERENCE

This application claims the priority based on Japanese Patent Application No. 2023-10315 filed on Jan. 26, 2023 under 35 U.S.C. 119. The contents of this application are incorporated herein by reference in their entirety.

### BACKGROUND

The present disclosure relates to a remote customer service system.

In recent years, more customers are being served by remote operators via communication lines such as the Internet or dedicated lines, and various techniques have been proposed to facilitate the smooth progress of remote customer service. An example technique that has been disclosed is to accept, from a customer terminal, a product and an area where the product is scheduled to be used, specify a corresponding salesperson based on the area where the product is scheduled to be used, and establish a communication between the customer terminal and a salesperson terminal.

### SUMMARY

A remote customer service system according to the present disclosure includes an acquiring device, a plurality of operator terminal devices, an operator selection device, and a store terminal device. The acquiring device acquires customer information including feature information indicating a feature of a customer who visits a store. The plurality of operator terminal devices are used in an operation to provide customer service information to the customer by a plurality of operators capable of serving the customer. The operator selection device selects one operator from the plurality of operators. The store terminal device is installed in the store, communicates with one of the operator terminal devices used in the operation to provide the customer information by an operator selected by the operator selection device, receives the customer service information from the operator terminal device, and provides the customer service information to the customer. The operator selection device includes a storage and a selector. The storage stores operator information indicating a characteristic of each of the plurality of operators. The selector selects an operator having a characteristic suitable for the customer who corresponds to the customer information acquired by the acquiring device based on the customer information and the operator information.

### BRIEF DESCRIPTION OF THE DRAWINGS

FIG. 1 is a schematic diagram illustrating a configuration of a remote customer service system according to a first embodiment.

FIG. 2 is a block diagram of the remote customer service system according to the first embodiment.

FIG. 3 illustrates an example of operator terminal information used in the remote customer service system according to the first embodiment.

FIG. 4 illustrates an example of operator information used in the remote customer service system according to the first embodiment.

FIG. 5 is a schematic diagram illustrating an example of customer service in the remote customer service system according to the first embodiment.

FIG. 6 illustrates a score table used in the remote customer service system according to the first embodiment.

FIG. 7 is a flowchart illustrating an operator selection method used in the remote customer service system according to the first embodiment.

FIG. 8 is a schematic diagram illustrating an example of customer service in a remote customer service system according to a second embodiment.

FIG. 9 illustrates operator information in the remote customer service system according to the second embodiment.

FIG. 10 illustrates a score table used in the remote customer service system according to the second embodiment.

FIG. 11 is a flowchart illustrating an operator selection method used in the remote customer service system according to the second embodiment.

FIG. 12 is a schematic diagram illustrating an example of customer service in a remote customer service system according to a third embodiment.

FIG. 13 illustrates sales floor information in the remote customer service system according to the third embodiment.

FIG. 14 illustrates a score table used in the remote customer service system according to the third embodiment.

FIG. 15 is a flowchart illustrating an operator selection method used in the remote customer service system according to the third embodiment.

### DETAILED DESCRIPTION

A remote customer service system 10 according to a first embodiment will be described below with reference to the attached drawings. In the drawings, the same reference signs are given to the same or similar components, and the description of such components will not be repeated.

### First Embodiment

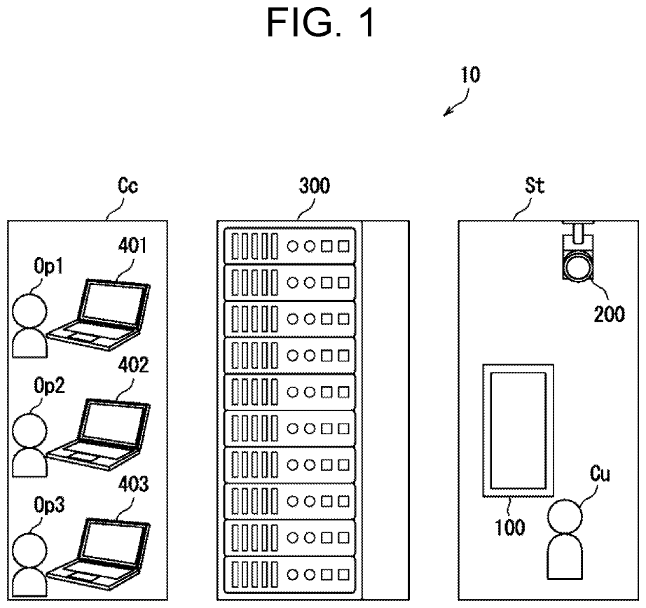

First, the remote customer service system 10 according to the first embodiment is described with reference to FIG. 1. FIG. 1 is a schematic diagram illustrating a configuration of the remote customer service system 10 according to the first embodiment.

As illustrated in FIG. 1, the remote customer service system 10 is a system that enables an operator Op in a remote place away from a store St to serve a customer Cu in the store St. For example, the remote customer service system 10 exchanges voices, video images, and/or messages between a customer Cu in the store St and one of a plurality of operators Op1 to Op3 in a call center Cc located at a place away from the store St. In the following, any one of the plurality of operators Op1 to Op3 may be representatively described as the operator Op.

The remote customer service system 10 includes a store terminal device 100, an acquiring device 200, and an operator selection device 300. The store terminal device 100 is installed in the store St. The store terminal device 100 is used for customer service of the customer Cu.

For example, the store terminal device 100 presents the customer Cu with information on products in the store St. In addition, the store terminal device 100 presents customer service information to the customer Cu. Here, the customer service information is the information presented to customers for the purpose of customer service, such as information on products sold in the store S, or the information on the store St, such as sales floor information indicating the positions of sales floors of a plurality of products in the store St.

For example, the store terminal device 100 outputs voice to the customer Cu. The store terminal device 100 may output voice of the operator Op. Alternatively, the store terminal device 100 may output a predetermined voice stored in advance.

In addition, the store terminal device 100 displays a video image to the customer Cu. The store terminal device 100 may display a video image of the operator Op. Alternatively, the store terminal device 100 may display a predetermined video image stored in advance.

In the present embodiment, the store terminal device 100 may be a device such as a personal computer (PC), a tablet terminal, or a smartphone. The store terminal device 100 may also be a digital signage.

The acquiring device 200 is, for example, an imager such as a camera. The acquiring device 200 captures an image of the interior of the store St. The acquiring device 200 is installed in the store St.

The acquiring device 200 captures an image in the store St. The acquiring device 200 generates captured image information based on the imaging. The acquiring device 200 captures an image of a predetermined range in the store St. The acquiring device 200 captures an image of the customer Cu in the store St and generates the captured image information, thus acquiring customer information. The captured image information includes feature information indicating features of the customer Cu who visits the store St.

Typically, the acquiring device 200 is installed near the store terminal device 100. For example, the acquiring device 200 may operate in conjunction with the store terminal device 100. Alternatively, the acquiring device 200 may be installed inside the store terminal device 100.

The operator selection device 300 is installed at a place different from the store St and the call center Cc. The operator selection device 300 assigns an operator OP who responds to the customer Cu in the store St. The operator selection device 300 is, for example, a so-called server.

The operator selection device 300 is connected to the acquiring device 200. The acquiring device 200 and the operator selection device 300 are connected to a communication line such as a public line or a dedicated line.

The operator selection device 300 receives the captured image information from the acquiring device 200. The operator selection device 300 receives the image capture information obtained by capturing an image of the vicinity of the store terminal device 100 from the acquiring device 200.

The remote customer service system 10 further includes a plurality of operator terminal devices 400. In one example, the remote customer service system 10 includes three operator terminal devices 401, 402, and 403 in FIG. 1. The operator terminal devices 401, 402, and 403 are installed in the call center Cc. The operator terminal device 401 is used by the operator Op1. The operator terminal device 402 is used by the operator Op2. The operator terminal device 403 is used by the operator Op3. In the present embodiment, the operator terminal device 400 may be a device such as a PC, a tablet terminal, or a smartphone. In the following, any one of the operator terminal devices 401, 402, and 403 may be representatively described as the operator terminal device 400.

The operator Op operates the operator terminal device 400 to exchange the video image and the voice with the customer Cu via the store terminal device 100, thus providing the customer service information to the customer. This enables remote customer service by the operator Op in the remote place.

The operator selection device 300 is also connected to the operator terminal device 400. The operator selection device 300 and the operator terminal device 400 are connected to a communication line such as a public line or a dedicated line.

The operator selection device 300 transmits control information to execute notification for prompting the operator Op to start customer service to the operator terminal device 400. Further, the operator selection device 300 receives customer service start information indicating the start of customer service by the operator Op from the operator terminal device 400.

The operator selection device 300 may also be connected to the store terminal device 100. The store terminal device 100 and the operator selection device 300 are connected to a communication line such as a public line or a dedicated line.

The operator selection device 300 connects the store terminal device 100 and the operator terminal device 400 based on the customer service start information. The operator selection device 300 also transmits the customer service information including the images, voices, and messages from the operator terminal device 400 to the store terminal device 100. The operator selection device 300 transmits the customer service information including the images, voices, and messages from the store terminal device 100 and/or the acquiring device 200 to the operator terminal device 400.

According to the remote customer service system 10 of the present embodiment, the operator Op located in a remote place can provide the customer service to the customer Cu who visits the store St.

The number of the store terminal devices 100 is not limited to one, and may be two or more. The configuration of the remote customer service system 10 will be specifically described below.

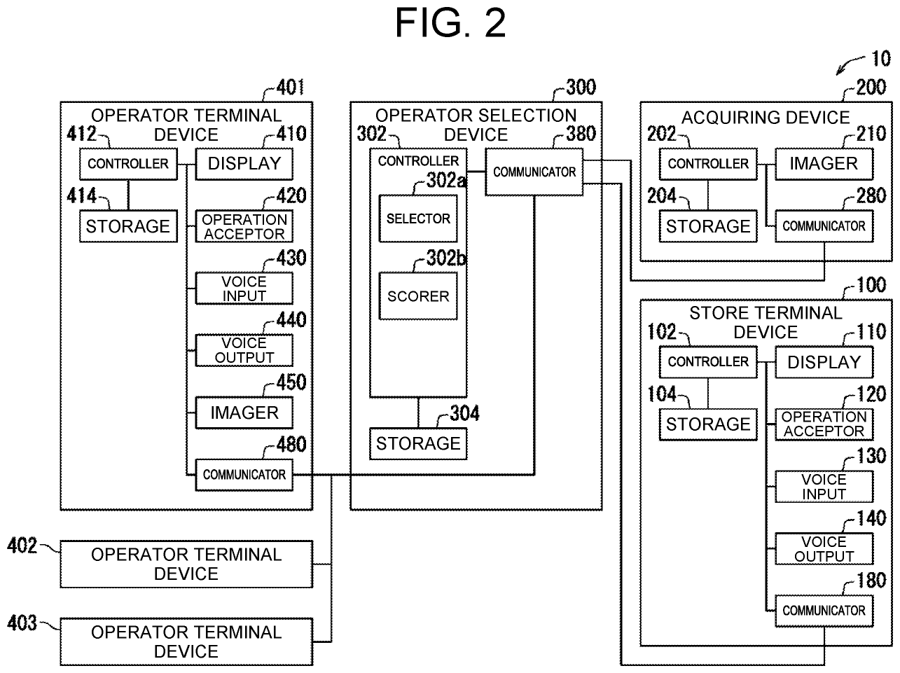

With reference to FIGS. 1 and 2, a remote customer service system 10 according to the first embodiment is described. FIG. 2 is a block diagram of the remote customer service system 10 according to the first embodiment.

As illustrated in FIG. 2, the remote customer service system 10 includes the store terminal device 100, the acquiring device 200, the operator selection device 300, and the operator terminal device 400. The operator selection device 300 controls the store terminal device 100, the acquiring device 200, and the operator terminal device 400.

The store terminal device 100 includes a controller 102, a storage 104, a display 110, an operation acceptor 120, a voice input 130, a voice output 140, and a communicator 180. The controller 102 controls the storage 104, the display 110, the operation acceptor 120, the voice input 130, the voice output 140, and the communicator 180.

The controller 102 includes a central processing unit (CPU).

The storage 104 includes a nonvolatile storage medium such as a hard disk drive. The storage 104 stores address information such as an IP address of the own terminal for remote customer service, and address information of the addresses and the like of the acquiring device 200, the operator selection device 300, and the operator terminal device 400. The storage 104 includes a memory (a read only memory (ROM) and a random access memory (RAM)). In the controller 102, the CPU executes a control program of a remote customer service application stored in the ROM.

The display 110 displays images. For example, the display 110 displays images of the operator Op, the products in the store St, and/or the images related to the store St. The display 110 allows the customer Cu to visually recognize the images of the operator Op, the products in the store St, and/or the images related to the store St.

The display 110 includes a display panel such as a liquid crystal panel and a drive circuit for driving the display panel (both not illustrated). Under the control of the controller 102, the drive circuit supplies, to the display panel, a drive signal for displaying an image of a subject captured by the acquiring device 200, a video image of a communication partner acquired via the communicator 180, and the like. The display panel displays images corresponding to the drive signal supplied from the drive circuit.

The operation acceptor 120 accepts the operation from the customer Cu. The operation acceptor 120 includes a mouse, a keyboard, a touch panel, and the like (none of which is illustrated). For example, the display 110 includes a touch panel. The operation acceptor 120 accepts the operation from the customer Cu and outputs an operation signal indicating the accepted operation to the controller 102.

The voice input 130 accepts voices in the store St. For example, the voice input 130 accepts the voice of the customer Cu and converts it into an electric signal. In one example, the voice input 130 is a microphone.

The voice input 130 collects voices around the store terminal device 100 and outputs a voice signal converted into an electric signal to the controller 102. Therefore, the voice input 130 can collect the voice around the store terminal device 100.

The voice output 140 outputs the voice in the store St. For example, the voice output 140 converts the electric signal that represents voice information indicating the voice of the operator Op into the voice and outputs it. In one example, the voice output 140 is a speaker.

The voice output 140 performs D/A conversion on the voice data output from the controller 102, amplifies it, and outputs the voice.

The communicator 180 is a communication interface for communicating with the operator selection device 300 via a communication line. The communicator 180 establishes communication with the operator selection device 300 using a communication protocol such as a real-time transport protocol (RTP) under the control of the controller 102. Specifically, the communicator 180 outputs data received from the operator selection device 300 to the controller 102, and transmits the data input from the controller 102 to the operator selection device 300.

The communicator 180 transmits and receives data to and from the operator terminal device 400 via the operator selection device 300. The communicator 180 may transmit and receive data to and from the acquiring device 200 via the operator selection device 300.

In the controller 102, the CPU executes the control program of the remote customer service application stored in the ROM in response to the operation of the customer Cu through the operation acceptor 120.

The acquiring device 200 includes a controller 202, a storage 204, an imager 210, and a communicator 280. The controller 202 controls the storage 204, the imager 210, and the communicator 280. The controller 202 includes a CPU.

The storage 204 includes a nonvolatile storage medium such as a hard disk drive. The storage 204 stores address information such as an IP address of the own terminal for remote customer service, and address information of the addresses and the like of the store terminal device 100, the operator selection device 300, and the operator terminal device 400. The storage 204 includes memories (ROM and RAM). In the controller 202, the CPU executes a control program of the remote customer service application stored in the ROM.

The imager 210 is constituted by a digital camera. The imager 210 outputs, to the controller 202, the captured image information obtained by capturing the image of a subject within the range of the angle of view of the imager 210. That is, the acquiring device 200 captures the image of the subject such as the customer Cu. The acquiring device 200 has imaging modes: normal mode and tracking mode. The tracking mode is a mode to focus a subject portion (tracking target) instructed by the controller 202, and continue tracking the trucking target capture the image until an instruction to end the tracking mode is received from the controller 202. In the tracking mode, an image surrounding a predetermined region including the tracking target (hereinafter, referred to as a tracking image) is superimposed on the captured image. The normal mode is a mode in which a subject within the angle of view is automatically auto-focused and photographed.

The communicator 280 is a communication interface for communicating with the operator selection device 300 via a communication line. The communicator 280 establishes communication with the operator selection device 300 using a communication protocol such as RTP under the control of the controller 202. Specifically, the communicator 280 outputs data received from the operator selection device 300 to the controller 202, and transmits data input from the controller 202 to the operator selection device 300.

The communicator 280 transmits and receives data to and from the acquiring device 200 via the operator selection device 300. The communicator 280 may transmit and receive data to and from the operator terminal device 400 via the operator selection device 300.

In the controller 202, the CPU executes a control program of the remote customer service application stored in the ROM.

The operator selection device 300 includes a controller 302, a storage 304, and a communicator 380. The controller 302 controls the storage 304 and the communicator 380. The controller 302 includes a CPU.

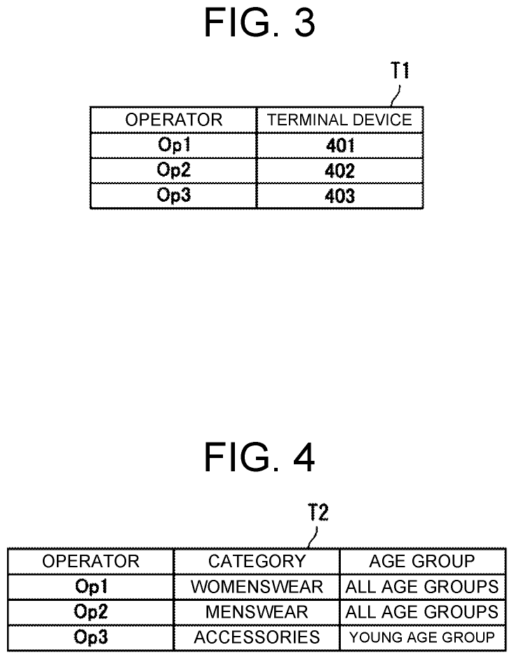

The storage 304 includes a nonvolatile storage medium such as a hard disk drive. The storage 304 stores address information such as an IP address of the own terminal for remote customer service, and address information of the addresses and the like of the store terminal device 100, the acquiring device 200, and the operator terminal device 400. In addition, the storage 304 stores operator terminal information T1 (FIG. 3) indicating a correspondence relationship between the operators Op1 to Op3 and the operator terminal devices 401 to 403 and operator information T2 (FIG. 4) indicating characteristics of each operator Op.

In addition, the storage 304 includes memories (ROM and RAM). In the controller 302, the CPU executes a control program of the remote customer service application stored in the ROM.

In the controller 302, the CPU executes a control program of the remote customer service application stored in the ROM. The controller 302 selects the operator terminal device 400 corresponding to the operator Op who has features suitable for the customer Cu corresponding to the customer information included in the captured image information acquired by the acquiring device 200 by the CPU executing the control program. The controller 302 scores each of the operators Op1 to Op3 based on the customer information and the operator information T2 by the CPU executing the control program.

Thus, the controller 302 functions as the selector 302a and the scorer 302b by the CPU executing the control program to perform the remote customer service process. That is, one or both of the selector 302a and the scorer 302b are constituted by an electronic circuit. The processing in the selector 302a and the scorer 302b will be described later.

The communicator 380 is a communication interface for communicating with the acquiring device 200 via a communication line. The communicator 380 establishes communication with the acquiring device 200 using a communication protocol such as RTP under the control of the controller 302. Specifically, the communicator 380 outputs data received from the acquiring device 200 to the controller 302, and transmits data input from the controller 302 to the acquiring device 200.

The communicator 380 transmits and receives data to and from the store terminal device 100.

The communicator 380 transmits and receives data to and from the operator terminal device 400.

The operator terminal device 400 includes a controller 412, a storage 414, a display 410, an operation acceptor 420, a voice input 430, a voice output 440, an imager 450, and a communicator 480. The controller 412 controls the storage 414, the display 410, the operation acceptor 420, the voice input 430, the voice output 440, the imager 450, and the communicator 480.

The controller 412 includes a CPU.

The storage 414 includes a nonvolatile storage medium such as a hard disk drive. The storage 414 stores address information such as an IP address of the own terminal for remote customer service, and address information of the addresses and the like of the store terminal device 100, the acquiring device 200, and the operator selection device 300. The storage 414 includes memories (ROM and RAM). In the controller 412, the CPU executes a control program of the remote customer service application stored in the ROM.

The display 410 displays images related to the store St. The display 410 allows the operator Op to visually recognize the images related to the customer Cu.

The display 410 includes a display panel such as a liquid crystal panel and a drive circuit for driving the display panel (both not illustrated). Under the control of the controller 412, the drive circuit supplies, to the display panel, a drive signal for displaying an image of a subject captured by the acquiring device 200, a video image of a communication partner acquired via the communicator 480, and the like. The display panel displays images corresponding to the drive signal supplied from the drive circuit.

The operation acceptor 420 accepts the operation from the operator Op. The operation acceptor 420 includes a mouse, a keyboard, a touch panel, and the like (none of which is illustrated). The display 410 includes a touch panel. The operation acceptor 420 accepts the operation from the operator Op and outputs an operation signal indicating the operation of the operator Op to the controller 412.

The voice input 430 accepts the voice in the call center Cc. For example, the voice input 430 accepts the voice of the operator Op and converts it into an electric signal. For example, the voice input 430 is a microphone.

The voice input 430 collects the voice around the operator terminal device 400, converts the voice into an electric signal, and outputs it to the controller 412. Therefore, the voice input 430 can collect voice around the operator terminal device 400.

The voice output 440 outputs voice in the call center Cc. For example, the voice output 440 converts the electric signal indicating the voice information representing the voice of the customer Cu into voice and outputs it. In one example, the voice output 440 is a speaker.

The voice output 440 performs D/A conversion on the voice data output from the controller 412, and amplifies and outputs the voice data.

The imager 450 is constituted by a digital camera. The imager 450 outputs, to the controller 412, the captured image information obtained by capturing the image of a subject within the range of the angle of view of the imager 450. The imager 450 may be capable of tracking like the imager 210 of the acquiring device 200.

The communicator 480 is a communication interface for communicating with the operator selection device 300 via a communication line. The communicator 480 establishes communication with the operator selection device 300 using a communication protocol such as RTP under the control of the controller 412. Specifically, the communicator 480 outputs data received from the operator selection device 300 to the controller 412, and transmits data input from the controller 412 to the operator selection device 300.

The communicator 480 transmits and receives data to and from the store terminal device 100 via the operator selection device 300. The communicator 480 may transmit and receive data to and from the acquiring device 200 via the operator selection device 300.

In the controller 412, the CPU executes the control program of the remote customer service application stored in the ROM according to the operation of the operator Op through the operation acceptor 420.

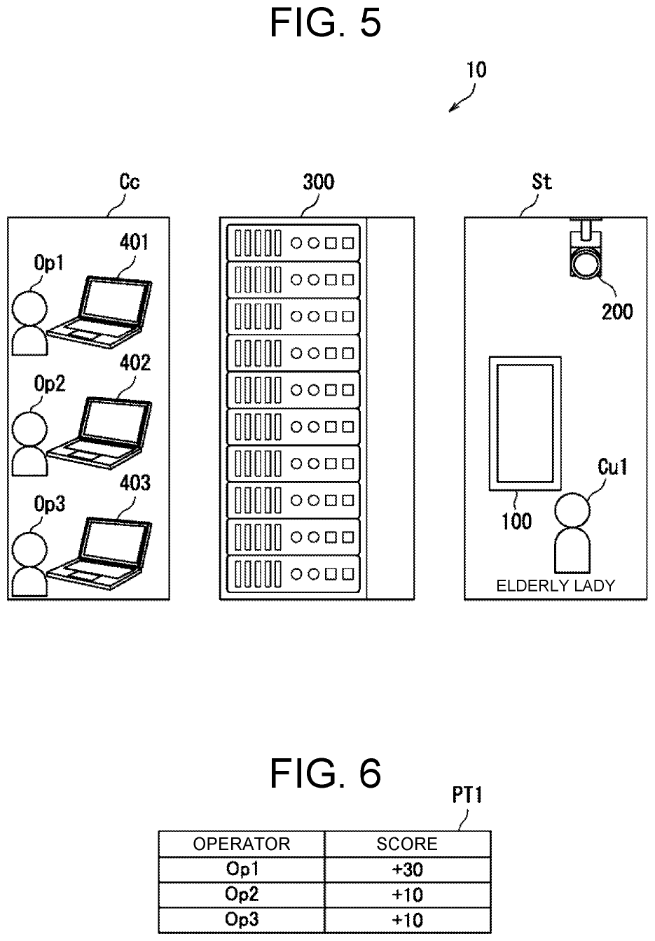

With reference to FIGS. 1 to 6, the selection of the operator terminal device 400 by the operator selection device 300 is described. FIG. 3 illustrates an example of operator terminal information T1 used in the remote customer service system 10 according to the first embodiment. FIG. 4 illustrates an example of operator information T2 used in the remote customer service system 10 according to the first embodiment. FIG. 5 is a schematic diagram illustrating an example of customer service in the remote customer service system 10 according to the first embodiment. FIG. 6 illustrates a score table PT1 used in the remote customer service system 10 according to the first embodiment.

As illustrated in FIG. 3, the operator terminal information T1 represents a correspondence relationship between the operator Op and the operator terminal device 400. Specifically, the operator Op1 corresponds to the operator terminal device 401. That is, the operator Op1 uses the operator terminal device 401. The operator Op2 corresponds to the operator terminal device 402. That is, the operator Op2 uses the operator terminal device 402. The operator Op3 corresponds to the operator terminal device 403. That is, the operator Op3 uses the operator terminal device 403.

On the other hand, as illustrated in FIG. 4, the operator information T2 represents characteristics of each operator Op. The characteristics of the operator Op include, for example, the category of products of which the operator Op is in charge and the target age group. Specifically, the category of products in which the operator Op1 is in charge is womenswear, and the target age group of the operator Op1 is all age groups. The category of products in which the operator Op2 is in charge is menswear, and the target age group of the operator Op2 is all age groups. The category of products in which the operator Op3 is in charge is accessories, and the target age group of the operator Op3 is the young age group. The characteristics of the operator Op may be personal features, such as the age or sex of the operator Op, in addition to the category of products in charge and the target age group.

With reference to FIGS. 2 to 6, the customer service to a female customer Cu1 who visits the store St is described in detail as an example of customer service in the remote customer service system 10.

First, as illustrated in FIG. 5, the customer Cu1 performs the input operation on the store terminal device 100. For example, the customer Cu1 inputs an operation to the operation acceptor 120 (FIG. 2) of the store terminal device 100 or inputs voice to the voice input 130 (FIG. 2) of the store terminal device 100.

As illustrated in FIG. 2, the operation acceptor 120 accepts the operation from the customer Cu1 and outputs the operation signal indicating the accepted operation to the controller 102. The voice input 130 accepts a voice input from the customer Cu1 and outputs a voice signal converted into an electric signal from the accepted voice to the controller 102.

Upon receipt of the operation signal from the operation acceptor 120 or the voice signal from the voice input 130, the controller 102 controls the communicator 180 to transmit a signal indicating an imaging start instruction to start imaging by the acquiring device 200 to the acquiring device 200 via the operator selection device 300.

The communicator 280 of the acquiring device 200 receives the signal transmitted from the controller 202 via the communicator 180 and the operator selection device 300, and outputs the imaging start instruction indicated by the received signal to the controller 102. Upon receipt of the imaging start instruction, the controller 202 controls the imager 210 to capture the image of the customer Cu1.

The imager 210 images the customer Cu1 and generates captured image information. The imager 210 outputs the captured image information to the controller 202. The captured image information includes feature information indicating features of the appearance of the customer Cu1. The feature information is an example of the customer information. The controller 202 transmits the captured image information to the operator selection device 300 via the communicator 280.

The controller 302 of the operator selection device 300 receives the captured image information transmitted from the acquiring device 200 via the communicator 380, and acquires the feature information included in the captured image information. The scorer 302b in the controller 302 scores each of the operators Op1 to Op3 indicated in the operator information T2 based on the feature information acquired by the controller 302.

Specifically, the controller 302 analyzes the received captured image information and specifies the customer Cu1 and the feature of the customer Cu1. For example, the controller 302 specifies the customer Cu1 from the captured image by pattern matching of a part or all of the captured image with a reference image. The reference image is stored in advance in the storage 304 in association with the feature information. The controller 302 determines the feature information indicating that the specified customer Cu1 is “female” and “elderly” based on the reference image used for specifying the customer Cu1. In the controller 302, machine learning may be used to specify the customer Cu1 and the feature of the customer Cu1.

With reference to FIGS. 4 and 6, scoring by the scorer 302b (FIG. 2) on the operators Op1 to Op3 is described. The scorer 302b scores each of the operators Op1 to Op3 indicated in the operator information T2 based on the specified feature information.

For example, as illustrated in FIGS. 4 and 6, with respect to the feature information of “women”, the scorer 302b scores “+20” for the characteristic of “womenswear”, scores “0” for the characteristic of “menswear”, and scores “+10” for the characteristic of “accessories”. With respect to the feature information of “women”, the scorer 302b also scores “+10” for the characteristic of “all age groups”, and scores “0” for the characteristic of “young age”.

As a result, as illustrated in FIG. 6, the scorer 302b scores a total of “+30” for the operator Op1, scores a total of “+10” for the operator Op2, and scores a total of “+10” for the operator Op3.

The scoring of the operator Op in the present embodiment is based on the adding method in which a score is added according to the scoring criterion to the operator Op having a characteristic suitable for the feature information, but the method is not limited to this. Alternately, for example, the subtracting method in which a score is subtracted for the operator Op having an unsuitable characteristic, or the classifying method in which the operators Op are classified into a plurality of ranks according to the feature information may be used. The above-mentioned scores according to the scoring criterion are exemplary.

For example, the scorer 302b generates a score table PT1 showing the scoring result of the operators Op1 to Op3 and stores the score table in the storage 304.

With reference to FIGS. 2 and 6, the selection of the operator Op by the selector 302a (FIG. 2) is described. The selector 302a selects the operator OP1 having the highest score among the operators Op1 to Op3 with reference to the score table PT1 stored in the storage 304. That is, the selector 302a determines that the operator Op1 has a characteristic suitable for the customer Cu1 based on the scoring result for each of the operators Op1 to Op3, and selects the operator Op1 as an operator for serving the customer Cu1.

Furthermore, the selector 302a refers to the operator terminal information T1 (FIG. 3) of the storage 304 and identifies the operator terminal device 401 corresponding to the operator Op1. As described above, once the selector 302a selects the operator terminal device 401 corresponding to the operator Op1 having the characteristic suitable for the customer Cu1, the controller 302 (FIG. 2) transmits the control information to execute notification for prompting the operator Op1 to start customer service to the operator terminal device 401 via the communicator 380. The controller 302 receives customer service start information indicating the start of customer service by the operator Op1 from the operator terminal device 401 via the communicator 380. The operator Op1 operates the operator terminal device 401 to perform the operation of providing the customer service information including the voices and messages to the customer.

The controller 302 connects the store terminal device 100 and the operator terminal device 401 based on the received customer service start information. In addition, the controller 302 transmits customer service information including the images, voices, and messages from the operator terminal device 401 to the store terminal device 100 via the communicator 380. The store terminal device 100 receives the customer service information and present it to the customer Cu1. The controller 302 transmits the customer service information including the images, voices, and messages from the store terminal device 100 and/or the acquiring device 200 to the operator terminal device 401 via the communicator 380.

According to the remote customer service system 10 of the present embodiment, one operator Op suitable for the feature information is selected from the plurality of operators Op according to the feature information of the customer Cu. This facilitates the selection of the operator Op suitable for the customer Cu. As a result, the customer service which is comfortable for the customer Cu can be provided in the store St, while the improved sales performance can be expected.

Since the plurality of operators Op are scored, the operator selection device 300 can quantitatively compare the plurality of operators Op.

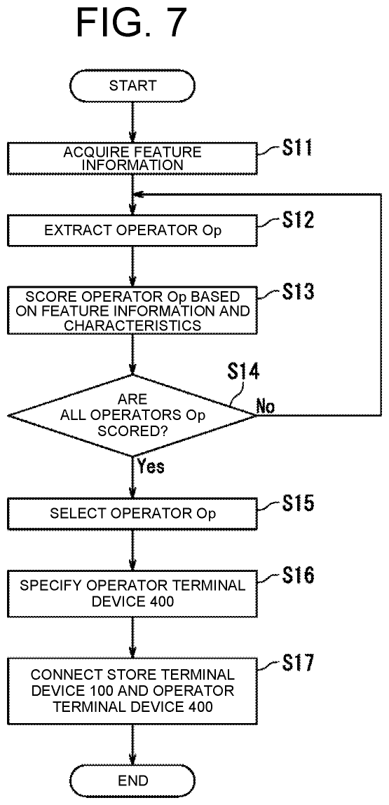

With reference to FIG. 7, an operator selection method used in the remote customer service system 10 according to the first embodiment is described. FIG. 7 is a flowchart illustrating an operator selection method used in the remote customer service system 10 according to the first embodiment.

First, upon acceptance of the operation from the customer Cu1, the store terminal device 100 controls the acquiring device 200 to acquire the feature information of the customer Cu1. The acquiring device 200 acquires the captured image information including the feature information of the customer Cu1 by capturing the image of the customer Cu1, and transmits the captured image information to the operator selection device 300. The operator selection device 300 receives the captured image information transmitted from the store terminal device 100 (step S11).

The operator selection device 300 extracts one operator Op from the plurality of operators Op indicated in the operator information T2 based on the stored operator information T2 (step S12).

The operator selection device 300 scores the extracted operator Op based on the feature information included in the received captured image information and the characteristics of the extracted operator Op indicated in the operator information T2 (step S13).

After scoring the extracted operator Op, the operator selection device 300 determines whether unscored operators Op are included in the operator information T2 by referring to the operator information T2 (step S14).

When the operator information T2 includes the unscored operators Op (No in step S14), the operator selection device 300 extracts one operator Op from the unscored operators Op (step S12).

On the other hand, when all the operators Op included in the operator information T2 are scored (Yes in step S14), the operator selection device 300 selects one operator Op from the plurality of operators Op indicated in the operator information T2 based on the scoring result (step S15).

The operator selection device 300 refers to the stored operator terminal information T1, and identifies the operator terminal device 400 corresponding to the selected operator Op (step S16).

The operator selection device 300 connects the specified operator terminal device 400 and the store terminal device 100. The operator terminal device 400 transmits the customer service information including the images, voices, and messages to the store terminal device 100 via the operator selection device 300. The store terminal device 100 receives the customer service information and presents it to the customer Cu1 (step S17).

### Second Embodiment

A remote customer service system 11 according to a second embodiment is described with reference to FIGS. 2 and 8 to 10. The second embodiment is different from the first embodiment in the scoring method of the operator Op. The following is a description of matters in the second embodiment that differ from those in the first embodiment, and the description of matters that overlap with those in the first embodiment will be omitted.

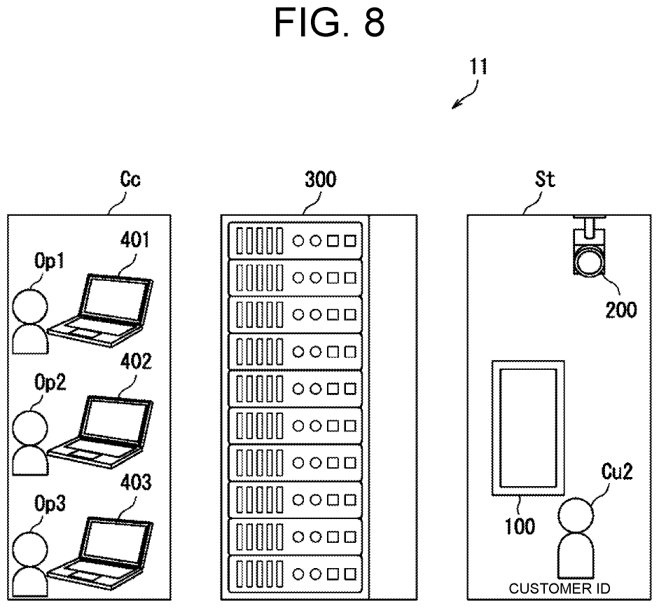

With reference to FIG. 8, the customer service for a customer Cu2 who visits the store St is specifically described as an example of the customer service in the remote customer service system 11 according to the second embodiment. FIG. 8 is a schematic diagram illustrating an example of the customer service in the remote customer service system 11 according to the second embodiment.

In the remote customer service system 11 according to the second embodiment, the customer Cu2 performs the operation of inputting the customer information to the store terminal device 100. For example, the customer Cu2 inputs the customer ID to the operation acceptor 120 (FIG. 2) of the store terminal device 100, or inputs the customer ID by voice to the voice input 130 (FIG. 2) of the store terminal device 100. The customer ID is an example of identification information for identifying the customer Cu2. Thus, in the remote customer service system 11 according to the second embodiment, the customer information includes the identification information.

For example, the customer ID may be input to the store terminal device 100 by the imager (the acquiring device 200) capturing and reading, for example, an image of characters indicating the customer ID or a barcode indicating the customer ID.

As illustrated in FIG. 2, the operation acceptor 120 accepts the operation from the customer Cu2 and outputs an operation signal indicating the accepted operation to the controller 102. The voice input 130 accepts the voice input from the customer Cu2 and outputs a voice signal converted into an electric signal from the accepted voice to the controller 102.

Upon receipt of the operation signal from the operation acceptor 120 or the voice signal from the voice input 130, the controller 102 acquires the customer ID included in the operation signal or the voice signal, and transmits the customer identification information including the acquired customer ID to the operator selection device 300 via the communicator 180.

The controller 302 of the operator selection device 300 receives the customer identification information transmitted from the store terminal device 100 via the communicator 380, and acquires the customer ID included in the customer identification information.

On the other hand, the acquiring device 200 generates the captured image information including characters or images indicating the customer ID and transmits the captured image information to the operator selection device 300.

The controller 302 of the operator selection device 300 receives the captured image information transmitted from the acquiring device 200 via the communicator 380, analyzes the characters or images indicated in the captured image information, and acquires the customer ID indicated by the characters or images.

The characters or images indicated in the captured image information may be analyzed by the acquiring device 200. In this case, the acquiring device 200 transmits the customer identification information including the customer ID, which is the analysis result, to the operator selection device 300. The controller 302 of the operator selection device 300 receives the customer identification information transmitted from the acquiring device 200 via the communicator 380, and acquires the customer ID included in the customer identification information.

In the present embodiment, for each of the plurality of customers Cu, the feature information indicating personal features such as the age or sex and the customer ID are associated with each other and stored as the customer information. The controller 302 specifies the customer Cu2 from the plurality of customers Cu based on the acquired customer ID.

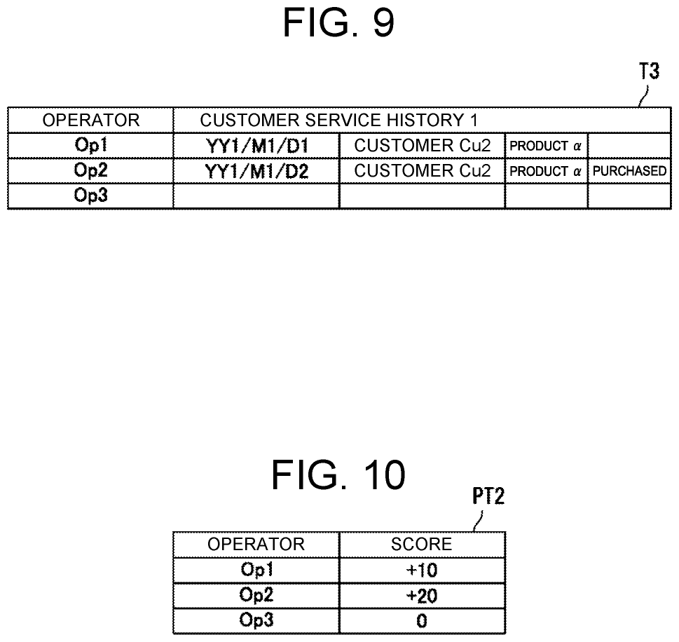

With reference to FIG. 9, a customer service history in the remote customer service system 11 according to the second embodiment is described. FIG. 9 illustrates operator information T3 in the remote customer service system 11 according to the second embodiment. Here, it is assumed that the operators OP1 to Op3 of the operator information T3 are unrelated to the operators Op1 to Op3 of the operator information T2 of the first embodiment.

The operator information T3 illustrated in FIG. 9 includes the customer service history indicating the customer Cu who has been serviced in the past by each of operators Op1 to Op3 and the date and time of the customer service. A process of generating the operator information T3 is described.

In one example, it is assumed that the customer Cu2 inputs the customer ID to the store terminal device 100 on the day D1 of the month M1 in the year YY. The controller 302 of the operator selection device 300 selects the operator Op1 from the operators Op1 to Op3 based on the customer ID input to the store terminal device 100. This selection is typically performed by a method different from the selection method of the operator Op described below, but may be performed by the same method as the selection method of the operator Op described below, or may be performed, for example, based on the operator information T2 of the first embodiment.

The controller 302 connects the store terminal device 100 and the operator terminal device 401 corresponding to the selected operator Op1. As a result, the customer service to the customer Cu2 by the operator Op1 is performed via the remote customer service system 11. The controller 302 generates the operator information T3 including the correspondence relationship between the day D1 of month M1 in year YY and the customer Cu2 as the customer service history 1 of the operator Op1.

In the customer service by the operator Cu2 for the customer Op1, when the input operation is performed on the remote customer service system 11 by the customer Cu2 or the operator Op1, the controller 302 updates the operator information T3 according to the input operation.

Specifically, the controller 302 adds the information indicating the customer service by the operator Op1 is the customer service regarding the “product α” to the customer service history 1 of the operator Op1. Here, it is assumed that the customer Cu2 had not purchased the “product α” on the day D1 of the month M1 in the year YY.

It is assumed that the customer Cu2 inputs the customer ID to the store terminal device 100 on the day D1 of the month M1 in the year YY, which is different from the day D2 of the month M1 in the year YY. At this time, it is assumed that the operator Op2 is selected by the operator selection device 300. The controller 302 refers to the storage 304 and updates the operator information T3 corresponding to the input customer ID. Specifically, the controller 302 adds the correspondence relationship between the day D2 of the month M1 in the year YY and the customer Cu2 to the operator information T3 as the customer service history 1 of the operator Op2. In addition, in a case where the customer service by the operator Op2 on the day D2 of the month M1 in the year YY is the customer service related to the “product α” and the customer Cu2 has been made to purchase the “product α”, the controller 302 updates the operator information T3 according to the input operation to the remote customer service system 11 by the customer Cu2 or the operator Op2. Specifically, the controller 302 adds the information indicating that the customer service by the operator Op2 is related to the “product α” and the information indicating that the “product α” has been purchased to the customer service history 1 of the operator Op2.

In this way, the customer service history indicates the operator Op who has serviced the customer Cu2 in the past and the date and time of the customer service by the operator Op. Since the customer service date and time indicated in the customer service history 1 of the operator Op2 in the operator information T3 is also the purchase date and time of the product, the customer service history 1 of the operator Op2 is also a purchase history indicating the purchase date and time of the product. In other words, the customer service history 1 of the operator Op2 includes a purchase history.

Furthermore, it is assumed that the customer Cu2 has inputted the customer ID to the store terminal device 100 after the day D2 of the month M1 in the year YY. The controller 302 of the operator selection device 300 scores each of the operators Op1 to Op3 indicated in the operator information T3 based on the customer IDs input to the store terminal device 100.

With reference to FIGS. 2, 9, and 10, scoring of the operators Op1 to Op3 by the scorer 302b (FIG. 2) in the remote customer service system 11 according to the second embodiment is described. FIG. 10 is a score table PT2 used in the remote customer service system 11 according to the second embodiment.

The scorer 302b gives a higher score to the operator Op who corresponds to the customer service history among the operators Op1 to Op3 than to other operators Op.

Specifically, the scorer 302b gives a higher score to the operator Op1 who has the customer service history 1 on the day D1 of the month M1 in the year YY with respect to the customer Cu2 and the operator Op2 who has the customer service history 1 on the day D2 of the month M1 in the year YY with respect to the customer Cu2 than to the operator Op3 who has no customer service history with respect to the customer Cu2.

Furthermore, the scorer 302b gives a higher score to the operator Op2 who has the customer service history 1 including the purchase history among the operators Op1 to Op3 than to the operators Op1 and Op3 who have no purchase history.

In one example, as illustrated in FIG. 10, the scorer 302b scores “+10”, “+20”, and “0” for the operators Op1 to Op3, respectively to generate a score table PT2 indicating the scoring result, and stores it in the storage 304.

With reference to the score table PT2 of the storage 304, the selector 302a (FIG. 2) selects the operator Op2 having the highest score among the operators Op1 to Op3.

Furthermore, the selector 302a refers to the operator terminal information T1 (FIG. 3) of the storage 304, and specifies the operator terminal device 402 corresponding to the operator Op2. The controller 302 (FIG. 2) transmits the control information to execute notification for prompting the operator Op2 to start customer service to the operator terminal device 402 via the communicator 380. The controller 302 receives the customer service start information indicating the start of customer service by the operator Op2 from the operator terminal device 402 via the communicator 380.

The controller 302 connects the store terminal device 100 and the operator terminal device 402 based on the received customer service start information.

In the remote customer service system 11 according to the second embodiment, a higher score is given to the operator Op having the customer service history. This facilitates the scoring of the operator Op who is familiar to the customer Cu2 with a higher score. As a result, the provision of the customer service which is comfortable for the customer Cu2 can be facilitated.

In addition, according to the remote customer service system 11 of the second embodiment, a higher score is given to the operator Op who has a purchase history. This facilitates the selection of the operator Op who has the sales record, while the improved sales can be expected in the store St.

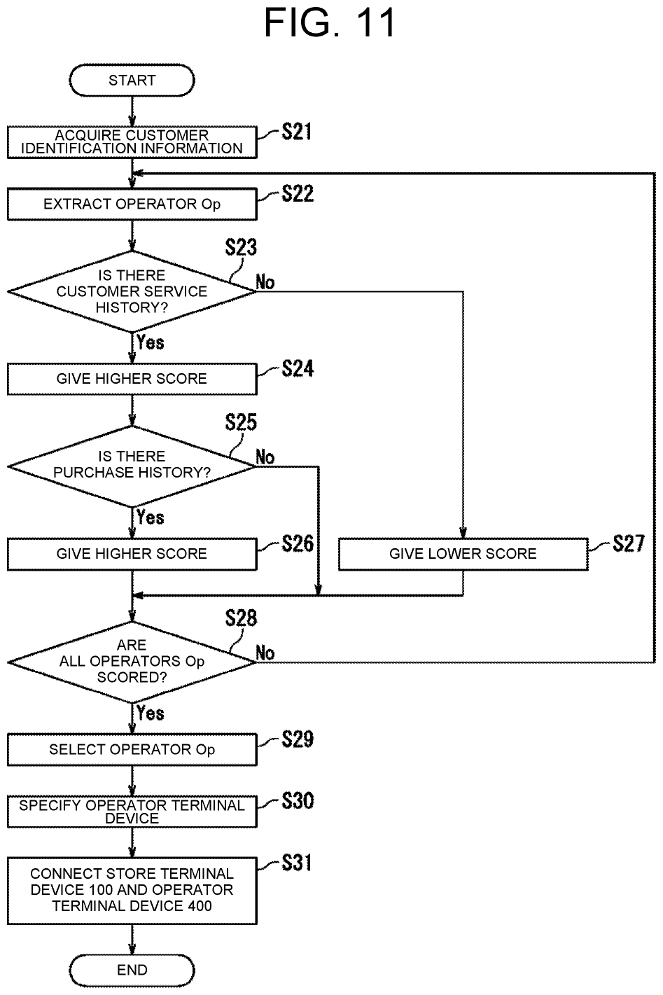

With reference to FIG. 11, an operator selection method used in the remote customer service system 11 according to the second embodiment is described. FIG. 11 is a flowchart illustrating the operator selection method used in the remote customer service system 11 according to the second embodiment.

First, upon acceptance of the input operation of the customer identification information from the customer Cu2, the store terminal device 100 acquires the customer identification information corresponding to the input operation and transmits it to the operator selection device 300. The operator selection device 300 receives the customer identification information transmitted from the store terminal device 100 (step S21).

The operator selection device 300 extracts one operator Op from the plurality of operators Op listed in the operator information T3 based on the stored operator information T3 (step S22).

The operator selection device 300 scores the extracted operator Op based on the received customer identification information and the customer service history of the extracted operator Op indicated in the operator information T3 (step S23).

In a case where the extracted operator Op has a service history for the customer Cu2 (Yes in step S23), the operator selection device 300 gives a higher score to the extracted operator Op than to other operators Op included in the operator information T3 (step S24).

Furthermore, in a case where the customer service history of the extracted operator Op includes the purchase history of the product with respect to the customer Cu2 (Yes in step S25), the operator selection device 300 gives a higher score to the extracted operator Op than to other operators Op included in the operator information T3 (step S26).

On the other hand, in a case where the service history of the customer Cu2 of the extracted operator Op includes no purchase history of the product (No in step S25), the operator selection device 300 gives a lower score than to the operator Op having the service history including the purchase history (step S27).

In a case where the extracted operator Op does not have a customer service history for the customer Cu2 (No in step S23), the operator selection device 300 gives a lower score than to the operator Op having a customer service history (step S27).

Upon scoring the extracted operator Op, the operator selection device 300 refers to the operator information T3 and determines whether unscored operators Op are included in the operator information T3 (step S28).

When the operator information T3 includes the unscored operators Op (No in step S28), the operator selection device 300 extracts one operator Op from the unscored operators Op (step S22).

On the other hand, when all of the operators Op included in the operator information T3 have been scored (Yes in step S28), the operator selection device 300 selects one operator Op from the plurality of operators Op indicated in the operator information T3 based on the scoring result (step S29).

The operator selection device 300 refers to the stored operator terminal information T1, and specifies the operator terminal device 400 corresponding to the selected operator Op (step S30).

The operator selection device 300 connects the specified operator terminal device 400 and the store terminal device 100. The operator terminal device 400 transmits the customer service information including the images, voices, and messages to the store terminal device 100 via the operator selection device 300. The store terminal device 100 receives the customer service information and present it to the customer Cu2 (step S31).

In the present embodiment, the date and time of the customer service indicates the year, month, and day, but may further include hours, minutes, and seconds.

### Third Embodiment

With reference to FIGS. 2 and 12 to 14, a remote customer service system 12 according to a third embodiment is described. The second embodiment is different from the first and second embodiments in the scoring method of the operator Op. Hereinafter, in the third embodiment, matters different from the first and second embodiments will be described, and the description of matters overlapping with the first and second embodiments will be omitted.

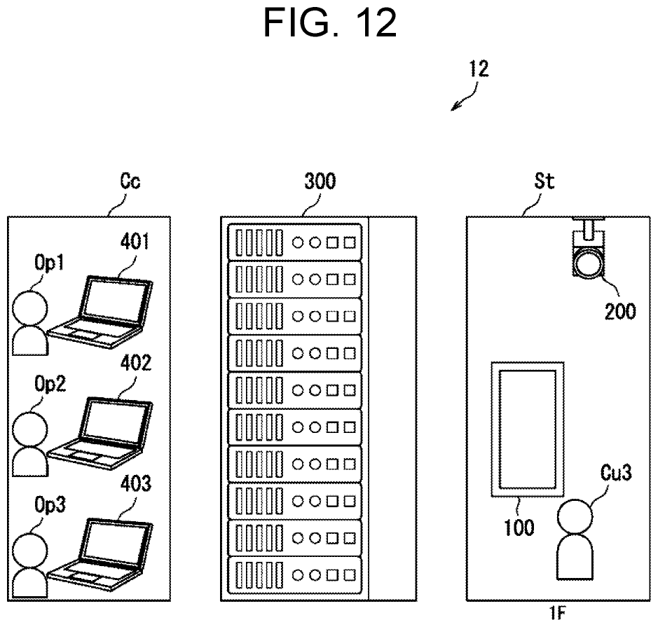

With reference to FIG. 12, in one example of the customer service in the remote customer service system 12 according to the third embodiment, the customer service for a customer Cu3 who visits the store St is specifically described. FIG. 12 is a schematic diagram illustrating an example of customer service in the remote customer service system 12 according to the third exemplary embodiment.

As illustrated in FIG. 12, the customer Cu3 performs the input operation on the store terminal device 100. For example, the customer Cu3 performs the input operation to the operation acceptor 120 (FIG. 2) of the store terminal device 100 or inputs voice to the voice input 130 (FIG. 2) of the store terminal device 100. The input operation to the store terminal device 100 by the customer Cu3 may include the input operation of the customer ID.

Upon receipt of the operation signal from the operation acceptor 120 or the voice signal from the voice input 130, the controller 102 controls the communicator 180 to transmit a signal indicating an imaging start instruction to start imaging by the acquiring device 200 to the acquiring device 200 via the operator selection device 300.

The communicator 280 of the acquiring device 200 receives the signal transmitted from the controller 102 via the communicator 180 and the operator selection device 300, and outputs the imaging start instruction indicated by the received signal to the controller 202. Upon receipt of the imaging start instruction, the controller 202 controls the imager 210 to capture the image of the customer Cu1.

The imager 210 captures the image of the customer Cu3 and generates the captured image information. The imager 210 outputs the captured image information to the controller 202. In the present embodiment, the storage 204 of the acquiring device 200 stores position information indicating a location where the acquiring device 200 is installed in the store St. In one example, the position information is, for example, a floor (a floor number) on which the acquiring device 200 is installed in the store St, or a location number indicating a place where the acquiring device 200 is installed on a certain floor in the store St. Upon receipt of the captured image information from the imager 210, the controller 202 acquires the position information from the storage 204. That is, by the controller 202 acquiring the position information of the acquiring device 200 that captures the image of the customer Cu3, the position of the customer Cu3 can be specified in the remote customer service system 12. In other words, the position information is also the information indicating the position of the customer Cu3.

The controller 202 transmits the captured image information and the position information to the operator selection device 300 via the communicator 280.

The controller 302 of the operator selection device 300 receives the captured image information and the position information transmitted from the acquiring device 200 via the communicator 380. The scorer 302b (FIG. 2) in the controller 302 scores each of the operators Op1 to Op3 indicated in the operator information T2 (FIG. 4) of the first embodiment based on the position information received by the controller 302.

In the present embodiment, the storage 304 of the operator selection device 300 stores sales floor information T4 indicating the positions of sales floors of a plurality of products in the store St.

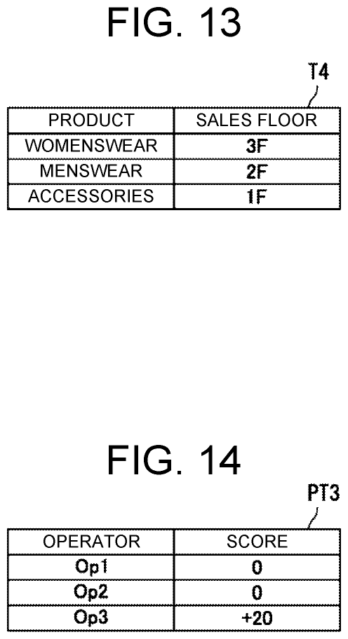

With reference to FIG. 13, sales floor information T4 in the remote customer service system 12 according to the third embodiment is described. FIG. 13 illustrates the sales floor information T4 in the remote customer service system 12 according to the third embodiment.

In one example, the sales floor information T4 indicates a correspondence relationship between the products and the sales floors of the products. Specifically, the sales floor (floor) of womenswear is “3F”. The sales floor (floor) of menswear is “2F”. The sales floor (floor) of accessories is “1F”.

With reference to FIGS. 2, 13, and 14, scoring the operators Op1 to Op3 by the scorer 302b in the remote customer service system 12 according to the third embodiment is described. FIG. 14 illustrates a score table PT3 used in the remote customer service system 12 according to the third embodiment.

The scorer 302b specifies the “sales floor” corresponding to the received position information and the “products” corresponding to the “sales floor” based on the sales floor information T4. For example, when the customer Cu3 illustrated in FIG. 12 operates the store terminal device 100 on “1F”, the acquiring device 200 transmits the position information indicating “1F” to the operator selection device 300.

The scorer 302b specifies the “sales floor” and the “products” corresponding to “1F” based on the received position information. The scorer 302b refers to the sales floor information T4 of the storage 304 and specifies that the “sales floor” and the “product” corresponding to “1F” are “accessories”.

The scorer 302b, then, scores each of the operators Op1 to Op3 according to the specified “sales floor” and “product”.

The scorer 302b gives a higher score to the operator Op who corresponds to the specified “sales floor” and “product” among the operators Op1 to Op3 than to other operators Op. Specifically, as illustrated in FIG. 14, the scorer 302b scores the operator Op3 who corresponds to the specified “accessories” to with “+20” which is higher than the score to the operators Op1 and Op2. On the other hand, the scorer 302b gives “0” to the operators Op1 and Op2 who do not correspond to the “accessories”. As described above, the characteristics indicated in the operator information T2 are also the information indicating the sales floor that the operator Op is in charge.

The scorer 302b generates a score table PT3 indicating the scoring result of the operators Op1 to Op3 and stores the score table in the storage 304.

With reference to the score table Op3 of the storage 304, the selector 302a (FIG. 2) selects the score table PT3 having the highest score among the operators Op1 to Op3.

Furthermore, the selector 302a refers to the operator terminal information T1 (FIG. 3) in the storage 304, and specifies the operator terminal device 403 corresponding to the operator Op3. The controller 302 (FIG. 2) transmits the control information to execute notification for prompting the operator Op3 to start customer service to the operator terminal device 403 via the communicator 380. The controller 302 receives the customer service start information indicating the start of customer service by the operator Op3 from the operator terminal device 403 via the communicator 380.

The controller 302 connects the store terminal device 100 and the operator terminal device 403 based on the received customer service start information.

According to the remote customer service system 12 of the third embodiment, the operator Op can be selected based on the position of the customer Cu3 in the store St. This facilitates the selection of the operator Op corresponding to the product desired by the customer Cu3.

In the present embodiment, the position information may be stored in the storage 104 of the store terminal device 100. In this case, the position information is, for example, the floor number on which the store terminal device 100 is installed in the store St, the location number at which the store terminal device 100 is installed, and the like. The store terminal device 100 transmits the signal indicating the imaging start instruction to start imaging by the acquiring device 200 to the acquiring device 200 via the operator selection device 300, and transmits the position information of the storage 104 to the operator selection device 300.

In the present embodiment, the store terminal device 100 or the acquiring device 200 can receive a global positioning system (GPS) signal, and the GPS signal received by the store terminal device 100 or the acquiring device 200 may indicate the coordinates as the position information.

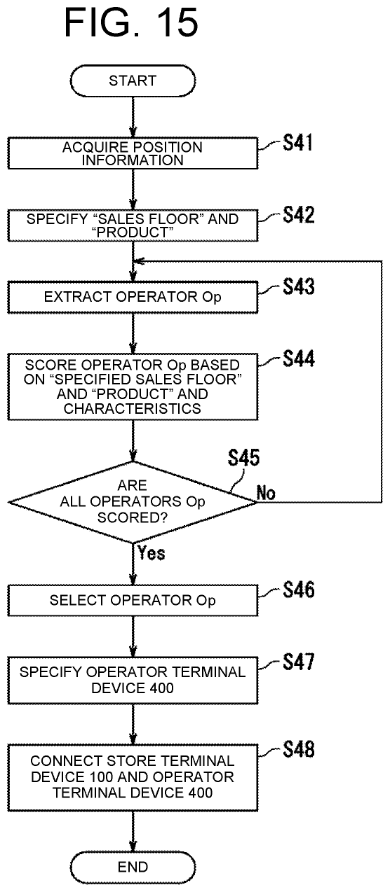

With reference to FIG. 15, an operator selection method used in the remote customer service system 12 according to the third embodiment is described. FIG. 15 is a flowchart illustrating an operator selection method used in the remote customer service system 12 according to the third embodiment.

First, upon acceptance of the operation from the customer Cu3, the store terminal device 100 controls the acquiring device 200 to capture the image of the customer Cu3. The acquiring device 200 captures the image of the customer Cu1 and acquires the captured image information. The acquiring device 200 acquires the stored position information and transmits the position information to the operator selection device 300 together with the captured image information. The operator selection device 300 receives the position information and the captured image information transmitted from the store terminal device 100 (step S41).

The operator selection device 300 specifies the “sales floor” corresponding to the received position information and the “product” corresponding to the “sales floor” based on the stored sales floor information T4 (step S42).

The operator selection device 300 extracts one operator Op from the plurality of operators Op indicated in the operator information T2 based on the stored operator information T2 (step S43).

The operator selection device 300 scores the extracted operator Op based on the specified “sales floor” and “product” and the characteristic of the extracted operator Op indicated in the operator information T2 (step S44).

When scoring the extracted operator Op, the operator selection device 300 determines whether unscored operators Op are included in the operator information T2 with reference to the operator information T2 (step S45).

When the operator information T2 includes the unscored operators Op (No in step S45), the operator selection device 300 extracts one operator Op from the unscored operators Op (step S43).

On the other hand, when all the operators Op included in the operator information T2 have been scored (Yes in step S45), the operator selection device 300 selects one operator Op from the plurality of operators Op indicated in the operator information T2 based on the scoring result (step S46).

The operator selection device 300 refers to the stored operator terminal information T1, and specifies the operator terminal device 400 corresponding to the selected operator Op (step S47).

The operator selection device 300 connects the specified operator terminal device 400 and the store terminal device 100. The operator terminal device 400 transmits the customer service information including the images, voices, and messages to the store terminal device 100 via the operator selection device 300. The store terminal device 100 receives the customer service information and presents it to the customer Cu1 (step S48).

The embodiments of the present disclosure have been described with reference to the attached drawings. However, the present disclosure is not limited to the embodiments described above, and can be implemented in various modes without departing from its spirit. A plurality of constituent elements disclosed in the embodiments described above can be changed, as necessary. For example, some of all the components illustrated in one embodiment may be added to the components of another embodiment, or some of all the components illustrated in one embodiment may be deleted from the embodiment.

For ease of understanding of the disclosure, the drawings are schematically illustrated mainly on the individual constituent elements, and the thicknesses, the lengths, the numbers, the intervals and the like of the constituent elements illustrated in the drawings may be different from the actual values for convenience of production of the drawings. The configurations of the constituent elements in the embodiments described above are examples, the present disclosure is not particularly limited and it is needless to say that various variations can be made without substantially departing from the effects of the present disclosure.

1. A remote customer service system comprising:
an acquiring device that acquires customer information including feature information indicating a feature of a customer who visits a store;
a plurality of operator terminal devices used in an operation to provide customer service information to the customer by a plurality of operators capable of serving the customer;
an operator selection device that selects one operator from the plurality of operators; and
a store terminal device installed in the store, communicating with one of the operator terminal devices used in the operation to provide the customer information by an operator selected by the operator selection device, receiving the customer service information from the operator terminal device, and providing the customer service information to the customer, wherein
the operator selection device includes
a storage that stores operator information indicating a characteristic of each of the plurality of operators, and
a selector that selects, based on the customer information and the operator information, an operator having a characteristic suitable for the customer who corresponds to the customer information acquired by the acquiring device.

2. The remote customer service system according to claim 1, wherein
the operator selection device further includes a scorer that scores each of the plurality of operators, based on the customer information and the operator information, and
the selector determines whether each of the plurality of operators has a characteristic suitable for the customer who corresponds to the customer information, based on a scoring result by the scorer, and selects the operator determined to have the characteristic suitable for the customer.

3. The remote customer service system according to claim 2, wherein
the customer information further includes identification information for identifying the customer,
the operator information includes a customer service history indicating an operator who has serviced the customer who corresponds to the identification information in the past and the date and time of the customer service by the operator, and
the scorer gives a higher score to the operator who corresponds to the customer service history among the plurality of operators than to the other operators.

4. The remote customer service system according to claim 3, wherein
when the customer has purchased a product during the past customer service to the customer, the customer service history includes a purchase history indicating a purchase date and time of the product, and
the scorer gives a higher score to the operator who corresponds to the operator information having the customer service history including the purchase history than to the other operators.

5. The remote customer service system according to claim 2, wherein
the storage further stores sales floor information indicating positions of sales floors of a plurality of products in the store,
the acquiring device acquires position information indicating a position of the customer in the store,
the characteristic indicated in the operator information includes information indicating a sales floor that each of the plurality of operators is in charge of, and
the scorer specifies a sales floor corresponding to the position information, based on the position information and the sales floor information, and gives a higher score to the operator who is in charge of the specified sales floor than to the other operators.
